(19) United States
(12) Patent Application Publication
(10) Pub. No.: US 2002/0182450 A1
(43) Pub. Date: Dec. 5, 2002

(54) Coated article with polymeric basecoat

(76) Inventors: Dimitris Katsamberis, Novi, MI (US); John G. Finch, Livonia, MI (US); Joseph A. Elmer, Lake Orion, MI (US); Patrick A. Sullivan, Niwot, CO (US)

Correspondence Address: Myron B. Kapustij, Masco Corporation, 21001 Van Born Road, Taylor, MI, 48180, US

(21) Appl. No.: 10/202,749

(22) Filed: Jul. 25, 2002

Related U.S. Application Data
(63) Continuation of application No. 09/747,248, filed on Dec. 21, 2000.

(51) Int. Cl. B32B 9/00

(52) U.S. Cl. 428/698; 428/458; 428/469; 428/472

(57) ABSTRACT

An article is coated with a multi-layer protective and decorative coating. The coating comprises a polymeric basecoat layer on the surface of said article, vapor deposited on the polymeric layer a stack layer comprised of alternating layers of refractory metal compound or refractory metal alloy compound alternating with refractory metal or refractory metal alloy, and vapor deposited on said stack layer a refractory metal compound or refractory metal alloy compound color layer.

### FIELD OF THE INVENTION

This invention relates to articles, particularly brass articles, having a multi-layered decorative and protective coating thereon.

### BACKGROUND OF THE INVENTION

It is sometimes the practice with various brass articles such as faucets, faucet escutcheons, door knobs, door handles, door escutcheons and the like to first buff and polish the surface of the article to a high gloss and to then apply a protective organic coating, such as one comprised of acrylics, urethanes, epoxies and the like, onto this polished surface. This system has the drawback that the buffing and polishing operation, particularly if the article is of a complex shape, is labor intensive. Also, the known organic coatings are not always as durable as desired, and are susceptible to attack by acids. It would, therefore, be quite advantageous if brass articles, or indeed other articles, either plastic, ceramic, or metallic, could be provided with a coating which provided the article with a decorative appearance as well as providing wear resistance, abrasion resistance and corrosion resistance. It is known in the art that a multi-layered coating can be applied to an article which provides a decorative appearance as well as providing wear resistance, abrasion resistance and corrosion resistance. This multi-layer coating includes a decorative and protective vapor deposited color layer of a refractory metal compound such as a refractory metal nitride, e.g., zirconium nitride or titanium nitride. Such a coating system is described, inter alia, in U.S. Pat. Nos. 5,552,233; 5,922,478; 5,654,108 and 6,033,790. However, these patents describe, and it is currently the practice, to provide an electroplated basecoat layer, such as nickel, over the substrate and beneath the vapor deposited layer(s). The application of the electroplated basecoat layer requires electroplating equipment which is cumbersome and expensive. It also requires a laborious and time consuming electroplating step on the article to be coated. It would thus be very advantageous if the electroplated basecoat could be eliminated or replaced by another basecoat. The present invention eliminates an electroplated basecoat.

### SUMMARY OF THE INVENTION

The present invention is directed to an article such as a plastic, ceramic or metallic article having a decorative and protective multi-layer coating deposited on at least a portion of its surface. More particularly, it is directed to an article or substrate, particularly a metallic article such as stainless steel, aluminum, brass or zinc, having deposited on its surface multiple superposed layers of certain specific types of materials. The coating is decorative and also provides corrosion resistance, wear resistance and abrasion resistance. The coating provides the appearance of highly polished brass or nickel, i.e. has a brass or nickel color tone. Thus, an article surface having the coating thereon simulates a brass or nickel surface.

The article first has deposited on its surface a polymeric basecoat layer. On top of the polymeric layer is then deposited, by vapor deposition such as physical vapor deposition, a stack layer. More particularly a first layer deposited directly on the surface of the substrate is comprised of a polymer. Disposed over the polymeric layer is a strike layer comprised of a refractory metal or refractory metal alloy such as zirconium, titanium, hafnium, tantalum or zirconium-titanium alloy, preferably zirconium, titanium or zirconium-titanium alloy. Over the strike layer comprised of refractory metal or refractory metal alloy is a stack or sandwich layer containing alternating layers of refractory metal compound or refractory metal alloy compound and a refractory metal or refractory metal alloy. Over the stack layer is a color layer comprised of a refractory metal compound or refractory metal alloy compound.

### BRIEF DESCRIPTION OF THE DRAWINGS

FIG. 1 is a cross sectional view of a portion of the substrate having a multi-layer coating comprising a polymeric basecoat and a stacked decorative or color and protective layer directly on the polymeric layer;

FIG. 2 is a view similar to FIG. 1 except that a refractory metal, such as zirconium, strike layer is present intermediate the polymeric layer and the stacked or sandwich layer; and

FIG. 3 is a view similar to FIG. 2 except that a refractory metal oxide layer is present on the stacked layer.

### DESCRIPTION OF THE PREFERRED EMBODIMENT

The article or substrate 12 can be comprised of any material onto which a plated layer can be applied, such as plastic, e.g., ABS, polyolefin, polyvinylchloride, and phenolformaldehyde, ceramic, metal or metal alloy. In one embodiment it is comprised of a metal or metallic alloy such as copper, steel, brass zinc, aluminum, nickel alloys and the like.

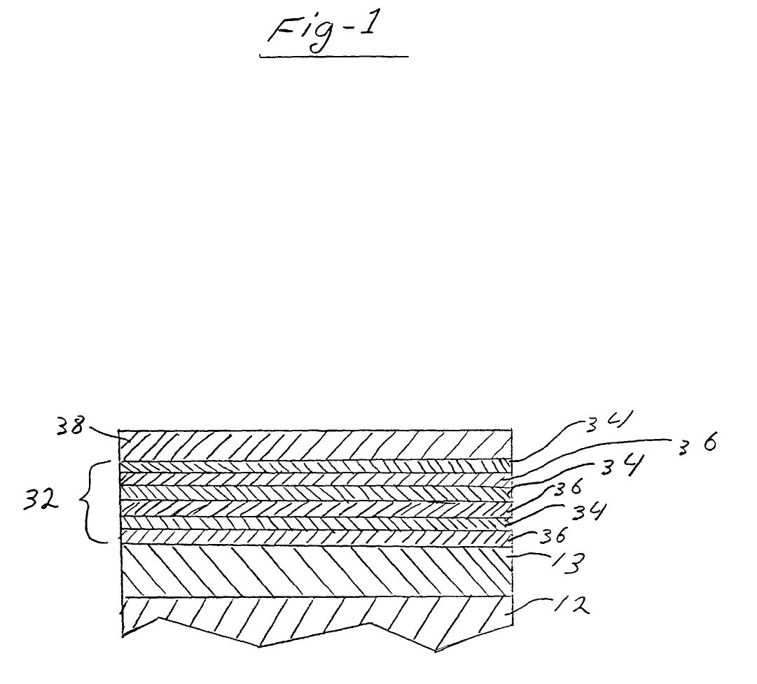

In the instant invention, as illustrated in FIGS. 1-3, a first polymeric or resinous basecoat layer 13 is applied onto the surface of the article 12. A second series of layers is applied onto the polymeric basecoat layer 13 by vapor deposition. The polymeric layer 13 serves, inter alia, as a basecoat which levels the surface of the article. The polymeric or basecoat layer 13 may be comprised of both thermoplastic and thermoset polymeric or resinous material. These polymeric or resinous materials include the well known, conventional and commercially available polycarbonates, epoxy urethanes, urethanes, polyacrylates, polymethacrylates, acrylic melamines, acrylic urethanes, epoxy melamines, nylons, polyesters, polypropylenes, polyepoxies, alkyds and styrene containing polymers such as polystyrene, styrene-acrylonitrile (SAN), styrene-butadiene, acrylonitrile-butadiene-styrene (ABS), and blends and copolymers thereof.

The polycarbonates are described in U.S. Pat. Nos. 4,579,910 and 4,513,037, both of which are incorporated herein by reference.

Nylons are polyamides which can be prepared by the reaction of diamines with dicarboxylic acids. The diamines and dicarboxylic acids which are generally utilized in preparing nylons generally contain from two to about 12 carbon atoms. Nylons can also be prepared by additional polymerization. They are described in “Polyamide Resins”, D. E. Floyd, Reinhold Publishing Corp., New York, 1958, which is incorporated herein by reference.

The polyepoxies are disclosed in “Epoxy Resins”, by H. Lee and K. Nevill, McGraw-Hill, New York, 1957, and in U.S. Pat. Nos. 2,633,458; 4,988,572; 4,680,076; 4,933,429 and 4,999,388, all of which are incorporated herein by reference.

The polyesters are polycondensation products of an aromatic dicarboxylic acid and dihydric alcohol. The aromic dicarboxylic acids include terephthalic acid, isophthalic acid, 4,4′-diphenyl-dicarboxylic acid, 2,6-naphthalenedicarboxylic acid, and the like. Dihydric alcohols include the lower alkane diols with from two to about 10 carbon atoms such as, for example, ethylene glycol, propylene glycol, cyclohexanedimethanol, and the like. Some illustrative non-limiting examples of polyesters include polyethylene terephthalate, polybutylene terephthalate, polyethylene isophthalate, and poly(1,4-cyclohexanedimethylene terephthalate). They are disclosed in U.S. Pat. Nos. 2,465,319; 2,901,466 and 3,047,539, all of which are incorporated herein by reference.

The polyacrylates and polymethacrylates are polymers or resins resulting from the polymerization of one or more acrylates such as, for example, methyl acrylate, ethyl acrylate, butyl acrylate, 2-ethylhexyl acrylate, etc., as well as the methacrylates such as, for instance, methyl methacrylate, ethyl methacrylate, butyl methacrylate, hexyl methacrylate, etc. Copolymers of the above acrylate and methacrylate monomers are also included within the term “polyacrylates or polymethacrylates” as it appears therein. The polymerization of the monomeric acrylates and methacrylates to provide the polyacrylate resins useful in the practice of the invention may be accomplished by any of the well known polymerization techniques.

The styrene-acrylonitrile and acrylonitrile-butadiene-styrene resins and their preparation are disclosed, inter alia, in U.S. Pat. Nos. 2,769,804; 2,989,517; 2,739,142; 3,991,136 and 4,387,179, all of which are incorporated herein by reference.

The alkyd resins are disclosed in “Alkyd Resin Technology”, Patton, Interscience Publishers, NY, N.Y., 1962, and in U.S. Pat. Nos. 3,102,866; 3,228,787 and 4,511,692, all of which are incorporated herein by reference.

The epoxy urethanes and their preparation are disclosed, inter alia, in U.S. Pat. Nos. 3,963,663; 4,705,841; 4,035,274; 4,052,280; 4,066,523; 4,159,233; 4,163,809; 4,229,335 and 3,970,535, all of which are incorporated by reference. Particularly useful epoxy urethanes are those that are electrocoated onto the article. Such electrodepositable epoxy urethanes are described in the aforementioned U.S. Pat. Nos. 3,963,663; 4,066,523; 4,159,233; 4,035,274 and 4,070,258.

These polymeric materials may optionally contain the conventional and well known fillers such as mica, talc and glass fibers.

The polymeric layer or basecoat layer 13 may be applied on the surface of the substrate by any of the well known and conventional methods such as dipping, spraying, brushing and electrodeposition.

The polymeric layer 13 functions, inter alia, to level the surface of the substrate, cover any scratches or imperfections in the surface of the article and provide a smooth and even surface for the deposition of the succeeding layers such as the vapor deposited layers.

The polymeric basecoat layer 13 has a thickness at least effective to level out the surface of the article or substrate. Generally, this thickness is at least about 1 um (micron), preferably at least about 2.5 um, and more preferably at least about 5.0 um, preferably about 100 um. The upper thickness range should generally not exceed about 250 um, preferably about 100 um.

The polymers can be cured in the usual and known manner such as, for example, by thermal or light energy.

In some instances, depending on the substrate material and the type of polymeric basecoat, the polymeric basecoat does not adhere sufficiently to the substrate. In such a situation a primer layer is deposited in the substrate to improve the adhesion of the polymeric basecoat to the substrate. The primer layer can be comprised, inter alia, of halogenated polyolefins. The halogenated polyolefins are conventional and well known polymers that are generally commercially available. The preferred halogenated polyolefins are the chlorinated and brominated polyolefins, with the chlorinated polyolefins being more preferred. The halogenated, particularly chlorinated, polyolefins along with methods for their preparation are disclosed, inter alia, in U.S. Pat. Nos. 5,319,032; 5,840,783; 5,385,979; 5,198,485; 5,863,646; 5,489,650 and 4,273,894, all of which are incorporated herein by reference.

The thickness of the primer layer is a thickness effective to improve the adhesion of the polymeric basecoat layer to the substrate. Generally this thickness is at least about 0.1 um (micron). The upper thickness is not critical and generally is controlled by secondary considerations such as cost and appearance. Generally an upper thickness of about 25 um should not be exceeded.

A sandwich or stack layer 32 comprised of alternating layers of refractory metal compound or refractory metal alloy compound 36 and refractory metal or refractory metal alloy 34 is deposited on the polymeric layer 13. The stack layer 32 is deposited by vapor deposition such as physical vapor deposition or chemical vapor deposition. The physical vapor deposition techniques are conventional and well known techniques including cathodic arc evaporation (CAE), reactive cathodic arc evaporation, sputtering, reactive sputtering, and the like. Sputtering techniques and equipment are disclosed, inter alia, in J. Vossen and W. Kern “Thin Film Processes II”, Academic Press, 1991; R. Boxman et al, “Handbook of Vacuum Arc Science and Technology”, Noyes Pub., 1955; and U.S. Pat. Nos. 4,162,954 and 4,591,418, all of which are incorporated herein by reference.

Briefly, in the sputtering deposition process a refractory metal (such as titanium or zirconium) target, which is the cathode, and the substrate are placed in a vacuum chamber. The air in the chamber is evacuated to produce vacuum conditions in the chamber. An inert gas, such as Argon, is introduced into the chamber. The gas particles are ionized and are accelerated to the target to dislodge titanium or zirconium atoms. The dislodged target material is then typically deposited as a coating film on the substrate.

In cathodic arc evaporation, an electric arc of typically several hundred amperes is struck on the surface of a metal cathode such as zirconium or titanium. The arc vaporizes the cathode material, which then condenses on the substrates forming a coating.

The refractory metals and refractory metal alloys comprising layers 34 include hafnium, tantalum, titanium, zirconium, zirconium-titanium alloy, zirconium-hafnium alloy, and the like, preferably zirconium, titanium, or zirconium-titanium alloy, and more preferably zirconium or zirconium-titanium alloy.

The refractory metal compounds and refractory, metal alloy compounds comprising layers 36 include hafnium compounds, tantalum compounds, titanium compounds, zirconium compounds, and zirconium-titanium alloy compounds, preferably titanium compounds, zirconium compounds, or zirconium-titanium alloy compounds, and more preferably zirconium compounds. These compounds are selected from nitrides, oxides, carbides and carbonitrides, with the nitrides being preferred. Thus, the titanium compound is selected from titanium nitride, titanium oxide, titanium carbide and titanium carbonitride, with titanium nitride being preferred. The zirconium compound is selected from zirconium nitride, zirconium carbide and zirconium carbonitride, with zirconium nitride being preferred.

In one embodiment the refractory metal compounds and refractory metal alloy compounds comprising layers 36 are the refractory metal nitrides and the refractory metal alloy nitrides. When these nitrides, for example zirconium nitride, contain substantially a stoichiometric amount of nitrogen they have a brass color. When these refractory metal nitrides and refractory metal alloy nitrides, for example zirconium nitride, have a low nitrogen content, i.e., substoichiometric, of from about 6 to about 45 atomic percent, preferably from about 8 to about 35 atomic percent, they have a nickel color.

The sandwich or stack layer 32 generally has an average thickness of from about 500 Å to about 1 um, preferably from about 0.1 um to about 0.9 um, and more preferably from about 0.15 um to about 0.75 um.

Each of layers 34 and 36 generally has a thickness of at least about 15 Å, preferably at least about 30 Å, and more preferably at least about 75 Å. Generally, layers 34 and 36 should not be thicker than about 0.38 um, preferably about 0.25 um, and more preferably about 0.1 um.

A method of forming the stack layer 32 is by utilizing sputtering or cathodic arc evaporation to deposit a layer 34 of refractory metal such as zirconium or titanium followed by reactive sputtering or reactive cathodic arc evaporation to deposit a layer 36 of refractory metal nitride such as zirconium nitride or titanium nitride.

Preferably the flow rate of nitrogen gas is varied (pulsed) during vapor deposition such as reactive sputtering between zero (no nitrogen gas is introduced) to the introduction of nitrogen at a desired value to form multiple alternating layers of metal 36 and metal nitride 34 in the sandwich layer 32.

The number of alternating layers of refractory metal or refractory metal alloy 34 and refractory metal compound or refractory metal alloy compound layers 36 in sandwich or stack layer 32 is generally at least about 2, preferably at least about 4, and more preferably at least about 6. Generally, the number of alternating layers of refractory metal alloy 34 and refractory metal compound or refractory metal alloy compound 36 in stack layer 32 should generally not exceed about 75, preferably about 50.

Over the stack layer 32 is a color layer 38. The color layer 38 is comprised of refractory metal compound or refractory metal alloy compound such as refractory metal nitride, e.g. zirconium nitride and titanium nitride. Layer 38 has a thickness at least effective to provide a color. Generally, this thickness is at least about 25 Å, and more preferably at least about 500 Å. The upper thickness range is generally not critical and is dependent upon secondary considerations such as cost. Generally a thickness of about 0.75 um, preferably about 0.63 um, and more preferably about 0.5 um should not be exceeded.

The color of the coating will generally be determined by the composition of the vapor deposited color layer 38. Thus, for example, if layer 38 is comprised of a titanium nitride it will have a gold color. If layer 38 is comprised of zirconium nitride containing about a stoichiometric amount of nitrogen it will have a brass color. If layer 38 is comprised of a refractory metal nitride such as zirconium nitride or a refractory metal alloy nitride such as zirconium-titanium alloy nitride wherein the nitride or nitrogen content is less than stoichiometric and generally from about 6 to about 45 atomic percent, preferably from about 8 to about 35 atomic percent it will have a nickel color.

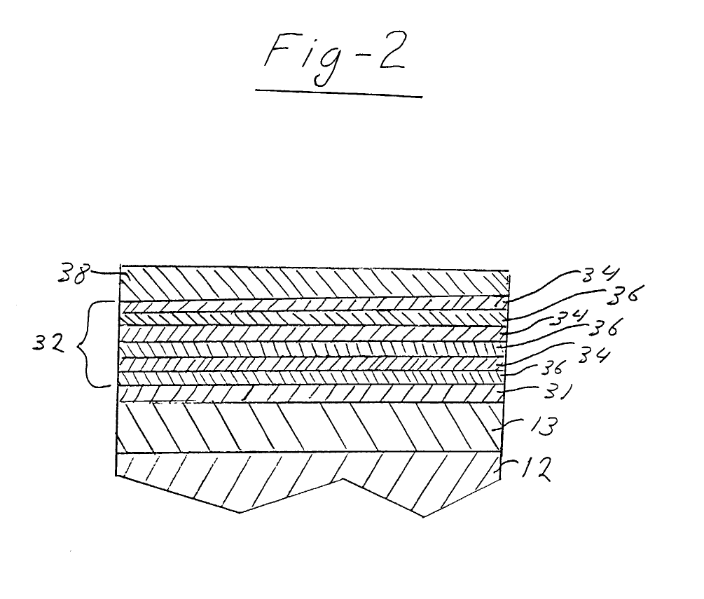

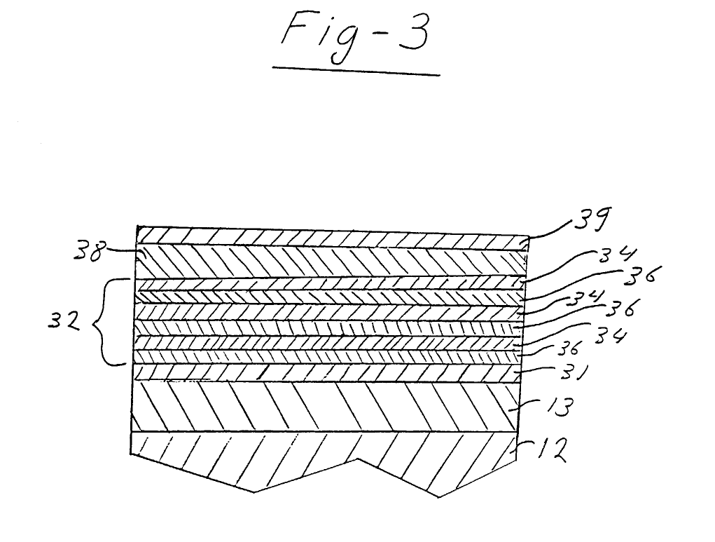

In one embodiment disposed intermediate stack layer 32 and the polymeric basecoat layer 13 is a refractory metal or refractory metal alloy layer 31. The refractory metal layer or refractory metal alloy layer 31 generally functions, inter alia, as a strike layer which improves the adhesion of the stack layer 32 to the polymeric layer. As illustrated in FIGS. 2 and 3, the refractory metal or refractory metal alloy strike layer 31 is generally disposed intermediate the stack layer 32 and the polymeric layer 13. Layer 31 has a thickness which is generally at least effective for layer 31 to function as a strike layer, i.e., improve the adhesion of the stack layer 32 to the polymeric layer 13. Generally, this thickness is at least about 60 Å, preferably at least about 127 Å, and more preferably at least about 250 Å. The upper thickness range is not critical and is generally dependent upon considerations such as cost. Generally, however, layer 31 should not be thicker than about 1.25 um, preferably about 0.40 um, and more preferably about 0.25 um.

In a preferred embodiment of the present invention the refractory metal of layer 31 is comprised of titanium or zirconium, preferably zirconium, and the refractory metal alloy is comprised of zirconium-titanium alloy.

In one embodiment of the invention as illustrated in FIG. 3 a layer 39 comprised of the reaction products of a refractory metal or metal alloy, an oxygen containing gas such as oxygen, and nitrogen is deposited onto stack layer 32. The metals that may be employed in the practice of this invention are those which are capable of forming both a metal oxide and a metal nitride under suitable conditions, for example, using a reactive gas comprised of oxygen and nitrogen. The metals may be, for example, tantalum, hafnium, zirconium, zirconium-titanium alloy, and titanium, preferably titanium, zirconium-titanium alloy and zirconium, and more preferably zirconium.

The reaction products of the metal or metal alloy, oxygen and nitrogen are generally comprised of the metal or metal alloy oxide, metal or metal alloy nitride and metal or metal alloy oxy-nitride.

Thus, for example, the reaction products of zirconium, oxygen and nitrogen comprise zirconium oxide, zirconium nitride and zirconium oxy-nitride. These metal oxides and metal nitrides including zirconium oxide and zirconium nitride alloys and their preparation and deposition are conventional and well known, and are disclosed, inter alia, in U.S. Pat. No. 5,367,285, the disclosure of which is incorporated herein by reference.

The layer 39 can be deposited by well known and conventional vapor deposition techniques, including reactive sputtering and cathodic arc evaporation.

In another embodiment instead of layer 39 being comprised of the reaction products of a refractory metal or refractory metal alloy, oxygen and nitrogen, it is comprised of refractory metal oxide or refractory metal alloy oxide. The refractory metal oxides and refractory metal alloy oxides of which layer 39 is comprised include, but are not limited to, hafnium oxide, tantalum oxide, zirconium oxide, titanium oxide, and zirconium-titanium alloy oxide, preferably titanium oxide, zirconium oxide, and zirconium-titanium alloy oxide, and more preferably zirconium oxide. These oxides and their preparation are conventional and well known.

Layer 39 is effective in providing improved chemical, such as acid or base, resistance to the coating. Layer 38 containing (i) the reaction products of refractory metal or refractory metal alloy, oxygen and nitrogen, or (ii) refractory metal oxide or refractory metal alloy oxide generally has a thickness at least effective to provide improved chemical resistance. Generally this thickness is at least about 10 Å, preferably at least about 25 Å, and more, preferably at least about 40 Å. Layer 39 should be thin enough so that it does not obscure the color of underlying color layer 38. That is to say layer 39 should be thin enough so that it is non-opaque or substantially transparent. Generally layer 39 should not be thicker than about 500 Å, preferably about 150 Å, and more preferably about 100 Å.

In order that the invention may be more readily understood, the following example is provided. The example is illustrative and does not limit the invention thereto.

### EXAMPLE

Brass faucets are placed in a conventional soak cleaner bath containing the standard and well known soaps, detergents, defloculants and the like which is maintained at a pH of 8.9-9.2 and a temperature of 180-200° F. for about 10 minutes.

A polymeric basecoat is applied on the faucets by using a high volume low pressure paint gun. The polymer is comprised 35 weight percent styrenated acrylic resin, 30 weight percent melamine formaldehyde resin and 35% bisphenol epoxy resin. The polymer is dissolved in butyl acetate solvent to allow a polymeric composition of 43 weight percent solids. After the basecoat application, the faucets are allowed to stand for a 20 minute ambient air flash off. The faucets are then baked at 375° F. for 2.5 hours. The resulting cured polymeric basecoat has a thickness of about 0.5 mil.

The polymer coated faucets are placed in a cathodic arc evaporation plating vessel. The vessel is generally a cylindrical enclosure containing a vacuum chamber which is adapted to be evacuated by means of pumps. A source of argon gas is connected to the chamber by an adjustable valve for varying the rate of flow of argon into the chamber. In addition, a source of nitrogen gas is connected to the chamber by an adjustable valve for varying the rate of flow of nitrogen into the chamber.

A cylindrical cathode is mounted in the center of the chamber and connected to negative outputs of a variable D.C. power supply. The positive side of the power supply is connected to the chamber wall. The cathode material comprises zirconium.

The polymer coated faucets are mounted on spindles, 16 of which are mounted on a ring around the outside of the cathode. The entire ring rotates around the cathode while each spindle also rotates around its own axis, resulting in a so-called planetary motion which provides uniform exposure to the cathode for the multiple faucets mounted around each spindle. The ring typically rotates at several rpm, while each spindle makes several revolutions per ring revolution. The spindles are electrically isolated from the chamber and provided with rotatable contacts so that a bias voltage may be applied to the substrates during coating.

The vacuum chamber is evacuated to a pressure of about 5×10⁻³ millibar and heated to about 150° C.

The coated faucets are then subjected to a high-bias arc plasma cleaning in which a (negative) bias voltage of about 500 volts is applied to the electroplated faucets while an arc of approximately 500 amperes is struck and sustained on the cathode. The duration of the cleaning is approximately five minutes.

Argon gas is introduced at a rate sufficient to maintain a pressure of about 2×10⁻¹ millibars. A layer of zirconium having an average thickness of about 4 millionths (0.000004) of an inch is deposited on the chrome plated faucets during a three minute period. The cathodic arc deposition process comprises applying D.C. power to the cathode to achieve a current flow of about 500 amps, introducing argon gas into the vessel to maintain the pressure in the vessel at about 2×10⁻¹ millibar and rotating the faucets in a planetary fashion described above.

After the zirconium layer is deposited a stack layer is applied onto the zirconium layer. A flow of nitrogen is introduced into the vacuum chamber periodically at a flow rate of about 500 sccm while the arc discharge continues at approximately 500 amperes. The nitrogen flow rate is pulsed, that is to say it is changed periodically from about 500 sccm and a flow rate of about zero. The period of the nitrogen pulsing is one to two minutes (30 seconds to one minute on, then of). The total time for pulsed deposition is about 15 minutes, resulting in a stack of about 10 to 15 layers of a thickness of about one to about 2.5 Å to about 75 Å for each layer.

After the stack layer is deposited, the nitrogen flow rate is left on at a flow rate of about 500 sccm for a period of time of about 5 to 10 minutes to form the color layer on top of the stack layer. After this zirconium nitride layer is deposited, an additional flow of oxygen of approximately 0.1 standard liters per minute is introduced for a time of thirty seconds to one minute, while maintaining nitrogen and argon flow rates at their previous values. A thin layer of mixed reaction products is formed (zirconium oxy-nitride), with thickness of approximately 50 Å-125 Å. The arc is extinguished at the end of this last deposition period, the vacuum chamber is vented and the coated substrates removed.

While certain embodiments of the invention have been described for purposes of illustration, it is to be understood that there may be various embodiments and modifications within the general scope of the invention.

We claim:

1. An article having on at least a portion of its surface a multi-layer protective and decorative coating comprising:
a layer comprised of polymer;
a stack layer comprised of plurality of alternating layers comprised of refractory metal compound or refractory metal alloy compound alternating with layers comprised of refractory metal or refractory metal alloy;
color layer comprised of refractory metal compound or refractory metal alloy compound.

2. The article of claim 1 wherein said refractory metal compound or refractory metal alloy compound is a nitride.

3. The article of claim 1 wherein a layer comprised of refractory metal oxide is on said color layer.

4. The article of claim 1 wherein a layer comprised of the reaction products of (i) refractory metal, (ii) oxygen and (iii) nitrogen is on said color layer.

5. The article of claim 1 wherein a layer comprised of refractory metal or refractory metal alloy is on said layer comprised of polymer.

6. The article of claim 2 wherein said refractory metal or refractory metal alloy in said refractory metal nitride or refractory metal alloy nitride is selected from the group consisting of zirconium, titanium and zirconium-titanium alloy.

7. The article of claim 6 wherein said refractory metal is zirconium.

8. The article of claim 1 wherein said refractory metal compound or refractory metal alloy compound comprising said stack layer is selected from the group consisting of oxides, carbides, carbonitrides and nitrides.

9. The article of claim 8 wherein said refractory metal compound or refractory metal alloy compound comprising said stack layer is refractory metal nitride or refractory metal alloy nitride.

10. The article of claim 9 wherein said refractory metal or refractory metal alloy is selected from the group consisting of zirconium, titanium, and zirconium-titanium alloy.

11. The article of claim 12 wherein said refractory metal is zirconium.

12. The article of claim 1 wherein said layer comprised of polymer is comprised of epoxy urethane.
